(19) United States
(12) Patent Application Publication
(10) Pub. No.: US 2003/0097612 A1
(43) Pub. Date: May 22, 2003

(54) System and method for analyzing and evaluation of an electric signal record

(75) Inventors: Doron Dinstein, Tel Aviv (IL); Barak Gordon, Rishon Le-Zion (IL); Goren Gordon, Rishon Le-Zion (IL)

Correspondence Address: LYON & LYON LLP, 633 WEST FIFTH STREET, SUITE 4700, LOS ANGELES, CA, 90071, US

(73) Assignee: Magnolia Medical Technologies, Ltd.

(21) Appl. No.: 10/143,508

(22) Filed: May 10, 2002

(30) Foreign Application Priority Data
Nov. 21, 2001 PCT/IL01/01074
Nov. 20, 2001 (IL) 146597

(51) Int. Cl. H04L 1/22

(52) U.S. Cl. 714/25

(57) ABSTRACT

A system and method for analysis and evaluation of electric data is disclosed. The method comprises receiving information from an input device; calculating complexity of the information received; calculating indicative parameter of the complexities; and analyzing and converting indicative parameter for final results. The system comprises an input device for capturing information; a computing device for calculating complexities of the captured information; analyzing and converting complexities into indicative parameters; interacting with storage device, user interface and input devices; a storage device for providing the computing device, user interface devices and input devices with storage space; storage of captured, analyzed and converted information; a user interface device for displaying information to the user; and interaction of user and system.

### CROSS REFERENCE TO RELATED APPLICATIONS

This application claims priority from PCT Application No. PCT/IL01/01074, filed Jan. 8, 2002, and Israeli Patent Application No. 146597, filed Nov. 20, 2001, each of which is hereby incorporated by reference as if fully set forth herein.

### BACKGROUND OF THE INVENTION

The present invention relates to electric potential data selection, analysis and summary for the facilitation of relevant data extraction, more specifically the analysis of medically related electric data for the facilitation of medical purposes, such as, for evaluation, diagnosis, treatment and prognosis.

The field of medical diagnosis is as ancient as medicine itself. During the last decade great discoveries led to significant advances in the medical diagnosis, treatment and prognosis. In ancient times clinical examination and physician intuition were the tools disposed to the physician for the achievement of diagnosis. The twentieth century has brought about great scientific discoveries and with them an explosion of new diagnostic tools.

The discovery of X-rays in the early 1900's has led to the development of the X-ray machine and later on Computerized Tomography (CT) machines. Ultra-Sound (US) imaging has emerged as a diagnostic tool following the second world war. The field of US imaging continued to develop and reached new heights with the use of the Doppler effect to demonstrate flow and motion of body parts. Imaging diagnosis continue to expand to include other forms of imaging such as nuclear scans, contrast based imaging and Magnetic Resonance Imaging (MRI).

The field of electric based diagnosis has produced diagnostic tools such as the Electrocardiogram (ECG) and Electroencephalogram (EEG). These tools measure the electric potential of different organs in the human body such as the heart and the brain, among others, and are represented as visual data called electric graphs.

The electric potential differences, measured between electrodes placed on the human body is used to produce an electric signal summed into Electric Data Record (EDR), generally referred to by names correlating with the organs or organ parts being examined. This data can also be saved or transferred for the purpose of further evaluation and consultation by other physicians.

Such tools present to the physician a great wealth of information regarding the human body anatomy, physiology, biochemistry, pathology etc. Interpretation of this data requires a great deal of expertise. Still, many physicians continue to interpret diagnostic information on a day to day basis.

The human observation capability, though elaborate and complex, is insufficient to analyze fully the enormous wealth of information contained within diagnostic images obtained today. Most physicians observe changes occurring from what is believed to be a normal examination.

When analyzing an EDR also referred to as an electric graph, such as an ECG strip, the trained physician will look for gross pattern differences from a predetermined, so called average normal ECG as well as compare the ECG strip of a particular patient to a previously done ECG. The changes sought for can include deviation of isoelectric lines from baseline, alteration in the length of interval between wave complexes, changes in the size and shape of wave complexes and the like. A thorough examination of an ECG strip may require special rulers and may take valuable time even for a trained physician. Even the most skilled physician may miss small alterations not readily visible to the human observer. Such alterations may be of importance to the medical diagnosis.

There is therefore a need in the art for a fast and more accurate diagnosis of the information contained within electrical graphs.

### SUMMARY OF THE INVENTION

A system and method for analysis and evaluation of electric data is disclosed.

The method comprises receiving information from an input device; calculating complexity of the information received; calculating indicative parameter of the complexities; and analyzing and converting indicative parameter for final results.

The system comprises an input device for capturing information; a computing device for calculating complexities of the captured information; analyzing and converting complexities into indicative parameters; interacting with storage device, user interface and input devices; a storage device for providing the computing device, user interface devices and input devices with storage space; storage of captured, analyzed and converted information; a user interface device for displaying information to the user; and interaction of user and system.

### BRIEF DESCRIPTION OF THE DRAWINGS

FIG. 1 illustrates parts of the system of the present invention; and

FIG. 2 illustrates operation of the system of the present invention.

### DETAILED DESCRIPTION OF PREFERRED EMBODIMENTS

Preferred embodiments will now be described with reference to the drawings. For clarity of description, any element numeral in one figure will represent the same element if used in any other figure.

The present invention provides for a system and method for analysis and evaluation of Electric Data Records (EDR) obtained from various instruments measuring electrical signals, more specifically electric potential. The system and method can be used for non-invasive diagnosis. The invention discloses a system and method according to which electrograph complexity calculation can be implemented on electric data recording of medical examination tools as well as other tools measuring and displaying electric data records. The input data is recorded in real-time via an electric potential sensitive machine previously described. A streaming data of different electric potentials referred to as Electrical Data Recording (EDR) is recorded digitally. The digital recording is received by the application. A complexity calculation of the at least a part of the data is performed. An indicative parameter is calculated using the complexity calculation according to predefined information obtained beforehand. The indicative parameter is used for calculation and transformation such that a final result can be displayed to the user. The final result can point to areas of interest in the EDR, facilitate diagnosis, and suggest treatment, used as a prognostic marker as well as other forms of medically relevant data. Thus, the output of the system is useful in the evaluation and quantification of Electric Data Records (EDR).

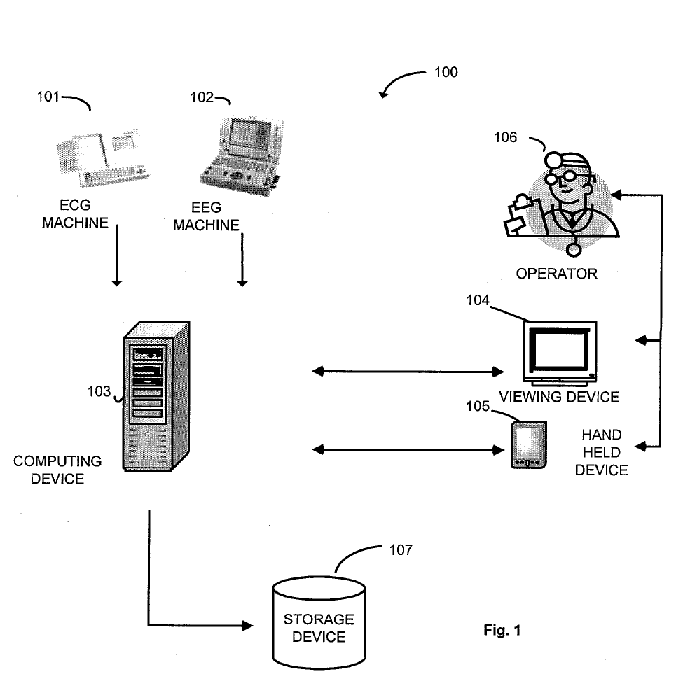

Turning now to FIG. 1 wherein parts of the system of the present invention are disclosed and referenced 100. Input device 101, 102 whereby data is obtained can be an electrocardiogram machine such as an ECG machine by Nihon-Kodan, manufactured in Japan, an electroencephalogram machine such as EEG by Nicolet—Viking 4, an Oscilloscope as well as any other instruments using electric signals, more specifically potential difference, to produce data or EDR such as an ECG, EEG, Electric Brain Stem Evoked Potential (EBSEP) and the like. In FIG. 1 only two input devices are depicted for the sake of clarity. It will be evident to the person skilled in the art that any number of input devices as well as different types of input devices can be connected to the computing device 103. Data obtained by input devices 101 and 102 is transferred via cable, modem, Infra Red (IR) or any other form known to a computing device 103. Computing device 103 is a software program or a hardware device such as a PC computer, such as a PC computer, a hand held computer such as Pocket PC and the like. Within the computing device 103 input received from input devices 101 and 102 is processed and an output data is transferred to the Interface devices 104 and 105. Interface devices may be a computer screen such as an LG Studioworks 57I, a hand held device such as the Palm Pilot manufactured by the Palm Corporation, a monitor screen, a Television screen, an interactive LCD screen, a paper record, as well as other interface devices. The output data can be stored on a storage device 107 such as a computer hard disk, as well as any storage device. The output data can also be sent for storage, viewing and manipulation to other parties by hard wire (not shown), IR device (not shown) or any other transfer modalities including via data network. Interface device 104 and 105 may be used to alter operation of input device 101 and 102, computing device 103 or both. Such activity can be done by the user 106 via direct human interaction with an interface device such as by touch, speech, manipulation of attached mouse device and the like. Output information can be viewed as graphs, pictures, summary analysis, and the like, as well as manipulated by the user 106 for other purposes such as transferring the data, saving the output and the like.

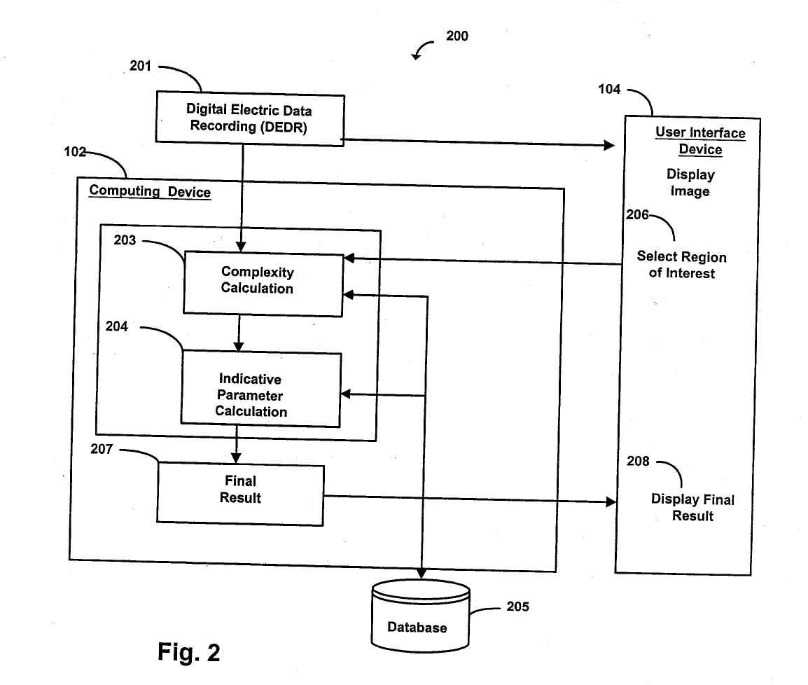

Turning now to FIG. 2 where operation of the system 200 of the present invention is disclosed where a streaming digital electric data recording (DEDR) 201 such as an electrocardiogram recording, a Holter recording, an encephalogram recording, a brain stem evoked potential recording and the like is obtained by input device 101 of FIG. 1. The DEDR 201 is transferred to computing device 102 as described also in FIG. 1. and then undergoes a complexity calculation 203 and Indicative parameter calculation 204. The complexity calculation 203 performed on the DEDR stream 201 is preferably done on at least one substantially small part of the data. Complexity calculation 203 can be performed automatically as predefined in parameters within Computing device 102 also of FIG. 1. Said calculation can be done on at least one substantially selected part of said data as predefined in predefined database 205. The calculation can also be performed on at least one substantially small selected region of interest 206 of said data by user (not shown) using the user interface device 104 also of FIG. 1. Indicative calculation 204, previously described in related application hereinabove is a quantitative data element calculated with respect to predefined parameters such as previously inputted DEDR streams (i.e., normal ECG result for an 18 year old African American male, etc.), predefined formulas describing known and predicted DEDR stream behavior and patterns (i.e., LAD deviation in an otherwise healthy 18 years old African American obese male, VT in trauma patients, etc.) as well as other parameters such as age, social circumstances, body stature, racial origin, occupation, previous illnesses, current illnesses and the like. Said data can be stored: before hand as well as stored continuously with operation. Said data can be stored on the predefined database 205 as well as on any database device (not shown) connected to Computing device 102 of FIG. 1 as well as any remote databases devices (also not shown). Calculated indicative parameter 204 can be displayed to the user (not shown) on the user interface device 104 also of FIG. 1. Said parameter can also be saved on the computing device 102 of FIG. 1 as well sent to other computer devices (not shown) by methods known in the art. Calculated indicative parameter 204 can be converted to an easy to understand, final result 207 such as a certainty of an electric data record (EDR) diagnosis, an image representation of the EDR, such as an electrograph, such as an ECG strip and the like, a summary of the streaming EDR input selected, a region of interest of the streaming EDR by predefined parameters located within the predefined database 205, a suggested immediate therapy indication and the like. Final result 207 is then transferred to the user interface 104 also of FIG. 1 and displayed 208 to the user (not shown).

DEDR stream 201 received from input devices 101 and 102 of FIG. 1 can be displayed to the user as an image display 209 during the system's operation. Thus allowing the user to observe and if needed to manipulate the system operation in real time using the user interface device 104 also of FIG. 1 as previously discussed.

The person skilled in the art will appreciate that what has been shown is not limited to the description above. Many modifications and other embodiments of the invention will be appreciated by those skilled in the art to which this invention pertains. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

What is claimed is:

1. A method for analysis and evaluation of electric data, the method comprising:
receiving information from an input device;
calculating complexity of the information received;
calculating indicative parameter of the complexities;
analyzing and converting indicative parameter for final results.

2. A system for analysis and evaluation of electric data, the system comprises:
an input device for capturing information;
a computing device for
calculating complexities of the captured information;
analyzing and converting complexities into indicative parameters;
interacting with storage device, user interface and input devices;
a storage device for
providing the computing device, user interface devices and input devices with storage space;
storage of captured, analyzed and converted information;
a user interface device for
displaying information to the user;
interaction of user and system.
